(19) United States
(12) Patent Application Publication
(10) Pub. No.: US 2025/0200348 A1
(43) Pub. Date: Jun. 19, 2025

(54) Model Compression Method and Apparatus, and Related Device

(71) Applicant: Huawei Technologies Co., Ltd., Shenzhen (CN)

(72) Inventors: Jing Lin, Hangzhou (CN); Yiwu Yao, Hangzhou (CN); Xihao Yuan, Shanghai (CN); Mengyang Zhang, Shanghai (CN)

(21) Appl. No.: 19/065,564

(22) Filed: Feb. 27, 2025

Related U.S. Application Data
(63) Continuation of application No. PCT/CN2023/114431, filed on Aug. 23, 2023.

(30) Foreign Application Priority Data
Aug. 30, 2022 (CN) 202211051840.1

(51) Int. Cl. G06N 3/0495; G06N 3/096

(52) U.S. Cl. CPC G06N 3/0495; G06N 3/096

(57) ABSTRACT

A model compression method includes obtaining a first weight of each layer of a neural network model, where the first weight of each layer is a value of a floating-point type; and quantizing the first weight of each layer based on a quantization parameter to obtain a second weight of each layer. The second weight of each layer is a multi-bit integer. Quantities of bits of second weights of at least a part of layers are different. A quantity of quantization bits of a second weight of a layer with high sensitivity to a quantization error is greater than a quantity of quantization bits of a second weight of a layer with low sensitivity to the quantization error.

### CROSS-REFERENCE TO RELATED APPLICATIONS

This is a continuation of International Patent Application No. PCT/CN2023/114431 filed on Aug. 23, 2023, which claims priority to Chinese Patent Application No. 202211051840.1 filed on Aug. 30, 2022, all of which are hereby incorporated by reference in their entireties.

### TECHNICAL FIELD

This application relates to the field of artificial intelligence, and in particular, to a model compression method and apparatus, and a related device.

### BACKGROUND

With the development of deep learning, neural networks are widely used in fields such as computer vision, natural language processing, and speech recognition. While precision of a neural network model is continuously improved, a structure of the neural network model tends to be complex, and a quantity of parameters is increasing. As a result, it is difficult to deploy the neural network model on a terminal or an edge device with limited resources. In another technology, a floating-point number in a neural network model is converted into a fixed-point number (usually an integer), so that a parameter size and memory consumption of the neural network model are effectively reduced. However, quantization usually causes deterioration of precision of the neural network model, and especially in a low-bit quantization scenario with a high compression ratio, a precision loss is greater.

### SUMMARY

Embodiments of this application provide a model compression method and apparatus, and a related device, to effectively reduce a precision loss.

According to a first aspect, a model compression method is provided, including obtaining a first weight of each layer of a neural network model, and quantizing the first weight of each layer based on a quantization parameter to obtain a second weight of each layer, where the first weight of each layer is a value of a floating-point type, the second weight of each layer is a multi-bit integer, quantities of bits of second weights of at least a part of layers are different, and a quantity of quantization bits of a second weight of a layer with high sensitivity to a quantization error is greater than a quantity of quantization bits of a second weight of a layer with low sensitivity to the quantization error.

In the foregoing solution, the first weight of the floating-point type in the neural network model is converted into the second weight that is an integer, and the quantity of quantization bits of the second weight of the layer with high sensitivity to the quantization error is greater than the quantity of quantization bits of the second weight of the layer with low sensitivity to the quantization error. Therefore, a precision loss is effectively reduced while the model is compressed.

In a possible design, quantization bits of the neural network model are generated. The first weight of each layer is quantized based on the quantization bits of the neural network model and the quantization parameter to obtain the second weight of each layer. The quantization bits of the neural network model include a quantity of quantization bits of each layer of the neural network model.

In a possible design, when a neural network model using the second weight does not meet a precision requirement, the second weight is optimized to obtain a third weight. The third weight is a multi-bit integer.

In the foregoing solution, the second weight may be further quantized to obtain the third weight with better effects.

In a possible design, a first quantization bit set is randomly generated. Iterative variation is performed on quantization bit sequences in the first quantization bit set for a plurality of times. A target quantization bit sequence is selected from quantization bit sequences obtained through variation, to obtain a second quantization bit set. A quantization bit sequence is selected from the second quantization bit set as the quantization bits of the neural network model. The first quantization bit set includes quantization bit sequences with a quantity a. Each quantization bit sequence in the first quantization bit set includes a quantity of bits of each layer of the neural network model.

In the foregoing solution, iterative variation may be performed for the plurality of times to select a quantization bit sequence with highest fitness and eliminate a quantization bit sequence with poor fitness layer by layer, so that a finally selected quantization bit sequence reduces the precision loss while ensuring a compressed ratio.

In a possible design, a third quantization bit set is obtained through variation based on the first quantization bit set. A fourth quantization bit set is randomly generated. The third quantization bit set and the fourth quantization bit set are merged to obtain a fifth quantization bit set. The first weight of each layer of the neural network model is quantized based on a quantity of bits of each layer in each quantization bit sequence in the fifth quantization bit set. Fitness of a neural network model obtained after quantization is performed through each quantization bit sequence in the fifth quantization bit set is determined. k quantization bit sequences with highest fitness are selected as a new first quantization bit set. The foregoing steps are repeated for a plurality of times until a quantity of repetition times reaches a threshold. A final first quantization bit set is determined as the second quantization bit set. The third quantization bit set includes b quantization bit sequences. The fourth quantization bit set includes c quantization bit sequences, where c is equal to a minus b. The fifth quantization bit set includes quantization bit sequences with a quantity a.

In a possible design, that the second weight is optimized includes optimizing the quantization parameter; or optimizing a student model through a teacher model, to optimize the second weight. The quantization parameter includes at least one of a scaling factor, a quantization offset, and a rounding manner. The teacher model is a neural network model using the first weight. The student model is a neural network model using the second weight.

In the foregoing solution, the second weight is further optimized, so that the precision loss of the neural network model can be further reduced.

In a possible design, the second weight of each layer or the third weight of each layer is combined to obtain a combined weight of each layer. A quantity of bits of the combined weight is the same as a quantity of bits supported by a processor using the neural network model. The combined weight of each layer is split to obtain the second weight of each layer or the third weight of each layer of the neural network model.

In the foregoing solution, a plurality of second weights or third weights may be combined and then stored, so that storage space for the neural network model is further compressed. In addition, adaptation to various processors may be performed. For example, it is assumed that the second weight is 4-bit. In this case, if the quantity of bits supported by the processor is 8 bits, two second weights may be combined together to form 8 bits; or if the quantity of bits supported by the processor is 16 bits, four second weights may be combined together to form 16 bits. In this way, a plurality of processors supporting different quantities of bits can be supported.

In a possible design, dequantization calculation is performed on the second weight of each layer or the third weight of each layer to obtain a restored first weight of each layer.

In the foregoing solution, when the neural network model needs to be used for calculation, the first weight may be restored through dequantization calculation, to obtain a high-precision neural network model.

According to a second aspect, a model compression apparatus is provided, including an obtaining module configured to obtain a first weight of each layer of a neural network model, where the first weight of each layer is a value of a floating-point type; and a quantization module configured to quantize the first weight of each layer based on a quantization parameter to obtain a second weight of each layer, where the second weight of each layer is a multi-bit integer, quantities of bits of second weights of at least a part of layers are different, and a quantity of quantization bits of a second weight of a layer with high sensitivity to a quantization error is greater than a quantity of quantization bits of a second weight of a layer with low sensitivity to the quantization error.

In a possible design, the apparatus further includes an optimization module. The optimization module is configured to: when a neural network model using the second weight does not meet a precision requirement, optimize the second weight to obtain a third weight. The third weight is a multi-bit integer.

In a possible design, the apparatus further includes a generation module. The generation module is configured to generate quantization bits of the neural network model. The quantization module is configured to quantize the first weight of each layer based on the quantization bits of the neural network model and the quantization parameter to obtain the second weight of each layer. The quantization bits of the neural network model include a quantity of quantization bits of each layer of the neural network model.

In a possible design, the generation module is configured to randomly generate a first quantization bit set, where the first quantization bit set includes quantization bit sequences with a quantity a, and each quantization bit sequence in the first quantization bit set includes a quantity of bits of each layer of the neural network model; perform iterative variation on the quantization bit sequences in the first quantization bit set for a plurality of times, and select a target quantization bit sequence from quantization bit sequences obtained through variation, to obtain a second quantization bit set; and select a quantization bit sequence from the second quantization bit set as the quantization bits of the neural network model.

In a possible design, the generation module is configured to obtain a third quantization bit set through variation based on the first quantization bit set, where the third quantization bit set includes b quantization bit sequences; randomly generate a fourth quantization bit set, where the fourth quantization bit set includes c quantization bit sequences, and c is equal to a minus b; merge the third quantization bit set and the fourth quantization bit set to obtain a fifth quantization bit set, where the fifth quantization bit set includes quantization bit sequences with a quantity a; and quantize the first weight of each layer of the neural network model based on a quantity of bits of each layer in each quantization bit sequence in the fifth quantization bit set, determine fitness of a neural network model obtained after quantization is performed through each quantization bit sequence in the fifth quantization bit set, select k quantization bit sequences with highest fitness as a new first quantization bit set, repeat the foregoing steps for a plurality of times until a quantity of repetition times reaches a threshold, and determine a final first quantization bit set as the second quantization bit set.

In a possible design, the optimization module is configured to optimize the quantization parameter. The quantization parameter includes at least one of a scaling factor, a quantization offset, and a rounding manner.

In a possible design, the optimization module is configured to optimize a student model through a teacher model, to optimize the second weight. The teacher model is a neural network model using the first weight. The student model is a neural network model using the second weight.

In a possible design, the apparatus further includes a combination module and a splitting module. The combination module is configured to combine the second weight of each layer or the third weight of each layer to obtain a combined weight of each layer. A quantity of bits of the combined weight is the same as a quantity of bits supported by a processor using the neural network model. The splitting module is configured to split the combined weight of each layer to obtain the second weight of each layer or the third weight of each layer of the neural network model.

In a possible design, the apparatus further includes a restoration module. The restoration module is configured to perform dequantization calculation on the second weight of each layer or the third weight of each layer to obtain a restored first weight of each layer.

According to a third aspect, an embodiment of the present disclosure provides a computing device. The computing device includes a processor, a memory, a communication interface, and a bus. The processor, the memory, and the communication interface may be connected to each other through an internal bus, or may communicate with each other in another manner, for example, wireless transmission. The memory may store computer instructions. The processor is configured to perform any possible implementation of the first aspect to implement functions of modules. The communication interface is configured to receive an input related signal.

According to a fourth aspect, an embodiment of the present disclosure provides a computing device cluster. The computing device cluster may be used in the method provided in the first aspect. The computing device cluster includes at least one computing device.

In specific implementation, the computing device may be a server, for example, a central server, an edge server, or a local server in a local data center. Alternatively, the computing device may be a terminal device, for example, a desktop computer, a notebook computer, or a smartphone.

In a possible implementation of the fourth aspect, memories of one or more computing devices in the computing device cluster may also separately store some instructions used to perform the model compression method. In other words, the one or more computing devices may be combined to jointly execute instructions used to perform the model compression method provided in the first aspect.

Memories of different computing devices in the computing device cluster may store different instructions to separately perform some functions of the model compression apparatus provided in the second aspect. In other words, the instructions stored in the memories of the different computing devices may implement functions of one or more modules in the obtaining module and the quantization module.

In a possible implementation of the fourth aspect, one or more computing devices in the computing device cluster may be connected through a network. The network may be a wide area network, a local area network, or the like.

According to a fifth aspect, an embodiment of the present disclosure provides a computer-readable storage medium. The computer-readable storage medium stores instructions. The instructions run on a computing device, so that the computing device performs the method in the foregoing aspects.

In this application, based on the implementations according to the foregoing aspects, the implementations may be further combined to provide more implementations.

### BRIEF DESCRIPTION OF DRAWINGS

To describe the technical solutions in embodiments of the present disclosure more clearly, the following briefly describes the accompanying drawings required for describing embodiments.

FIG. 1 is a schematic flowchart of a model compression method according to this application;

FIG. 2 is a schematic flowchart of generating quantization bits of a neural network model according to this application;

FIG. 3 is a schematic flowchart of performing iterative variation on a first quantization bit set for a plurality of times according to this application;

FIG. 4 is a schematic diagram of a structure of a model compression apparatus according to this application;

FIG. 5 is a schematic diagram of a structure of a computing device according to this application;

FIG. 6 is a schematic diagram of a structure of a computing device cluster according to this application; and

FIG. 7 is a schematic diagram of a structure of another computing device cluster according to this application.

### DESCRIPTION OF EMBODIMENTS

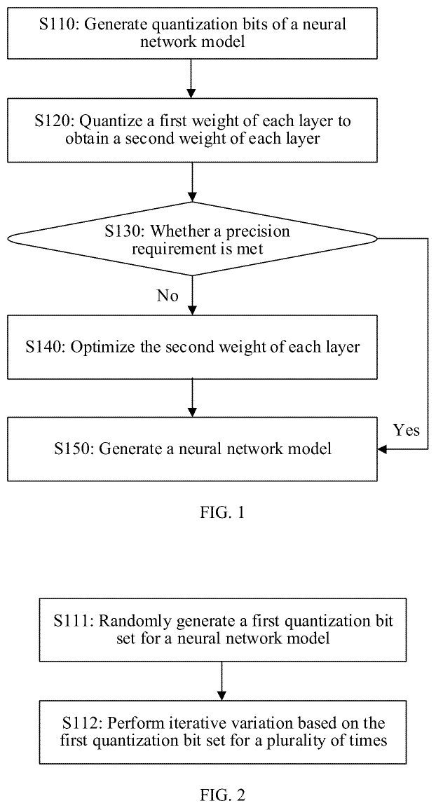

FIG. 1 is a schematic flowchart of a model compression method according to this application. As shown in FIG. 1, the model compression method in this application includes the following steps.

S110: A computing device generates quantization bits of a neural network model.

In some possible embodiments, the neural network model may be a deep neural network model, a convolutional neural network model, a recurrent neural network model, a variant of these neural network models, a combination of these neural networks, or the like. This is not specifically limited herein. The neural network model may include a plurality of layers. Each layer includes a plurality of first weights. The first weights are of a floating-point type. The first weight of each layer of the neural network model is obtained through training with a large amount of known data and labels corresponding to the known data.

In some possible embodiments, the quantization bits of the neural network model include a quantity of quantization bits of each layer of the neural network model. Herein, values of the quantization bits of the neural network model may be mixed. In other words, the quantities of quantization bits of the layers of the neural network model may be different. Because different layers of the neural network model have different sensitivity to a quantization error caused by quantization, a quantity of quantization bits of a weight of a layer with high sensitivity to the quantization error is large, and a quantity of quantization bits of a weight of a layer with low sensitivity to the quantization error is small. Therefore, a precision loss of the neural network model caused by quantization can be minimized while a compression ratio is ensured. For example, if a quantity of layers of the neural network model is 5, and the quantization bits of the neural network model are {2, 4, 8, 2, 2}, it indicates that a weight of a first layer of the neural network model is quantized into a 2-bit integer, a weight of a second layer of the neural network model is quantized into a 4-bit integer, a weight of a third layer of the neural network model is quantized into an 8-bit integer, a weight of a fourth layer of the neural network model is quantized into a 2-bit integer, and a weight of a fifth layer of the neural network model is quantized into a 2-bit integer. In the foregoing example, an example in which the quantity of layers of the neural network model is 5 and the quantization bits of the neural network model are {2, 4, 8, 2, 2} is used for description. In actual application, both the quantity of layers of the neural network model and the values of the quantization bits may be other values. This is not specifically limited herein.

In some possible embodiments, as shown in FIG. 2, a process in which the computing device generates the quantization bits of the neural network model may include the following steps.

S111: The computing device randomly generates a first quantization bit set for the neural network model.

In some more specific embodiments, the first quantization bit set includes quantization bit sequences with a quantity a. Each quantization bit sequence in the first quantization bit set includes a quantity of bits of each layer of the neural network model. The following provides description with reference to a specific embodiment. If the neural network model includes r layers, and the first quantization bit set includes a total of quantization bit sequences with a quantity a {X₁, X₂, . . . , Xₐ}, where Xᵢ includes {K₁, K₂, . . . , Kᵣ}, it indicates that a weight of a first layer of the neural network model is quantized into a K₁-bit integer, a weight of a second layer of the neural network model is quantized into a K₂-bit integer, . . . , and a weight of an r^{th} layer of the neural network model is quantized into a Kᵣ-bit integer. It should be understood that the quantization bit sequences in the first quantization bit set are all randomly generated, and they may be different from each other, but all need to ensure that the compression ratio can meet a requirement.

S112: The computing device performs iterative variation based on the quantization bit sequences in the first quantization bit set for a plurality of times, and selects a target quantization bit sequence with high fitness from quantization bit sequences obtained through variation, to obtain a second quantization bit set.

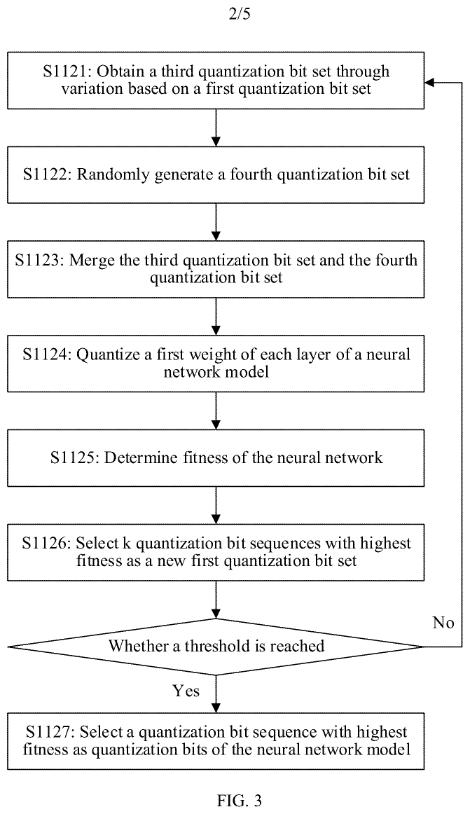

In some more specific embodiments, the computing device performs iterative variation on the quantization bit sequences in the first quantization bit set for the plurality of times, and selects the target quantization bit sequence with high fitness from the quantization bit sequences obtained through variation, to obtain the second quantization bit set. It may be understood that selection of a quantization bit sequence with highest fitness is merely used as a specific example. In actual application, a quantization bit sequence with second highest fitness, or the like may also be selected. This is not specifically limited herein. As shown in FIG. 3, the method includes the following steps.

S1121: The computing device obtains a third quantization bit set through variation based on the first quantization bit set.

In some more specific embodiments, the third quantization bit set may include b quantization bit sequences. Each of the b quantization bit sequences includes a quantity of bits of each layer of the neural network model. The third quantization bit set may include a smaller quantity of quantization bit sequences than those in the first quantization bit set, or may include a same quantity of quantization bit sequences as those in the first quantization bit set. This is not specifically limited herein.

In some more specific embodiments, variation may lead to two results. One is to obtain a quantization bit sequence with higher fitness (for example, with a high compression ratio but with a low precision loss), and the other is to obtain a quantization bit sequence with lower fitness (for example, with a low compression ratio but with a high precision loss). The quantization bit sequence with higher fitness is reserved. The quantization bit sequence with lower fitness is eliminated. After a plurality of iterations, a generation of quantization bit sequences with higher fitness can be generated.

In some more specific embodiments, the computing device may obtain the third quantization bit set through variation based on the first quantization bit set in at least one of the following two manners.

In a first manner, a quantization bit set S₁ is obtained through hybridization based on the first quantization bit set. Herein, a hybridization manner includes but is not limited to performing vector addition, vector subtraction, and the like on the quantization bit sequences in the first quantization bit set. In addition, vector addition, vector subtraction, and the like may be performed on two, three, or more quantization bit sequences. The following provides detailed description by using an example in which vector addition is performed on two quantization bit sequences:

$${S}_{1} = [ \frac{1}{2} {X}_{1} + \frac{1}{2} {X}_{2} , \frac{1}{2} {X}_{2} + \frac{1}{2} {X}_{3} , … , \frac{1}{2} {X}_{a - 1} + \frac{1}{2} {X}_{a} ]$$

$$\frac{1}{2} {X}_{1} + \frac{1}{2} {X}_{2} , + \frac{1}{2} {X}_{2} + \frac{1}{2} {X}_{3} , and … , \frac{1}{2} {X}_{a - 1} + \frac{1}{2} {X}_{a}$$

in the quantization bit set S₁ may be different from each other, but all need to ensure that the compression ratio can meet the requirement.

In a second manner, the first quantization bit set is changed to a quantization bit set S₂. Herein, a quantity of quantization bits of each layer in each quantization bit sequence in the first quantization bit set is changed to another value at a probability P. For example, it is assumed that the quantization bit sequence Xᵢ in the first quantization bit set includes {K₁, K₂, . . . , Kᵣ}, and variation is performed at a probability of 1/r. In this case, the quantization bit sequence Xᵢ may be changed to a quantization bit sequence Xᵢ′={K₁, K₂, K₃′, . . . , Kᵣ}, where K₃′ is obtained through variation of K₃.

It may be understood that the quantization bit set S₁ and the quantization bit set S₂ may be merged to obtain the third quantization bit set. Hybridization and changing may be simultaneously performed on the first quantization bit set to obtain the third quantization bit set. Alternatively, hybridization may be first performed on the first quantization bit set to obtain the quantization bit set S₁, and then the quantization bit set S₁ is changed to obtain the third quantization bit set; the first quantization bit set may be first changed to obtain the quantization bit set S₂, and then hybridization is performed on the quantization bit set S₂ to obtain the third quantization bit set; or the like.

S1122: Randomly generate a fourth quantization bit set.

In some more specific embodiments, the fourth quantization bit set may include c quantization bit sequences, and c is equal to a minus b. Each of the c quantization bit sequences includes a quantity of bits of each layer of the neural network model. When variation is performed in step S1121, a quantity of quantization bit sequences obtained through variation is usually less than a quantity of quantization bit sequences in the original first quantization bit set. The fourth quantization bit set needs to be randomly generated for supplement, to ensure that iteration can be performed for a plurality of times.

S1123: Merge the third quantization bit set and the fourth quantization bit set to obtain a fifth quantization bit set, where the fifth quantization bit set includes quantization bit sequences with a quantity a.

S1124: Quantize the first weight of each layer of the neural network model based on a quantity of bits of each layer in each quantization bit sequence in the fifth quantization bit set.

In some more specific embodiments, quantizing the first weight of each layer of the neural network model based on the quantity of bits of each layer in each quantization bit sequence in the fifth quantization bit set includes grouping the first weights in the neural network model by layer. In other words, all first weights of the first layer of the neural network model may be used as a first group, all first weights of the second layer of the neural network model may be used as a second group, the rest may be deduced by analogy, and all first weights of a last layer of the neural network model may be used as a last group. It may be understood that in the foregoing solution, different layers are used as different groups for processing. In actual application, each layer of the neural network model may be further grouped based on a convolution channel. This is not specifically limited herein.

Statistics on data distribution of each group of first weights is collected, including a minimum value min_val and a maximum value max_val of each group of first weights. Then, a scaling factor and a quantization offset are calculated. Finally, each group of weights are quantized based on the scaling factor and the quantization offset. An integer quantization range of n-bit quantization is [−2ⁿ⁻¹, 2ⁿ⁻¹−1]. Details are as follows.

A process of quantizing all the first weights of the first layer of the neural network model is as follows. Statistics on data distribution of the first weights of the first layer is collected, including a minimum value min_val_1 and a maximum value max_val_1 of the first weights of the first layer. Then, a scaling factor and a quantization offset of the first weight of the first layer are calculated:

$$\begin{matrix}{scale}_{1} = \frac{max\_val \_ 1 - min\_val \_ 1}{{2}^{{n}_{1}} - 1} \\ {offset}_{1} = round ( ( - {2}^{{n}_{1} - 1} ) - \frac{min\_val \_ 1}{{scale}_{1}} )\end{matrix}$$

Herein, scale₁ is the scaling factor of the first layer of the neural network model, offset₁ is the quantization offset of the first layer of the neural network model, min_val_1 is the minimum value of the first weights of the first layer, max_val_1 is the maximum value of the first weights of the first layer, round( ) is rounding, and n₁ is a quantity of bits used for the first layer of the neural network model, for example, 2 bits or 4 bits.

Finally, all the first weights of the first layer of the neural network model are quantized based on the scaling factor scale₁ and the quantization offset offset₁.

A process of quantizing all the first weights of the second layer of the neural network model is as follows. Statistics on data distribution of the first weights of the second layer is collected, including a minimum value min_val_2 and a maximum value max_val_2 of the first weights of the second layer. Then, a scaling factor and a quantization offset of the first weight of the second layer are calculated:

$$\begin{matrix}{scale}_{2} = \frac{max\_val \_ 2 - min\_val \_ 2}{{2}^{{n}_{1}} - 1} \\ {offset}_{2} = round ( ( - {2}^{{n}_{2} - 1} ) - \frac{min\_val \_ 2}{{scale}_{2}} )\end{matrix}$$

Herein, scale₂ is the scaling factor of the second layer of the neural network model, offset₂ is the quantization offset of the second layer of the neural network model, min_val_2 is the minimum value of the first weights of the second layer, max_val_2 is the maximum value of the first weights of the second layer, round( ) is rounding, and n₂ is a quantity of bits used for the second layer of the neural network model, for example, 2 bits or 4 bits.

Finally, all the first weights of the second layer of the neural network model are quantized based on the scaling factor scale₂ and the quantization offset offset₂.

The rest may be deduced by analogy.

A process of quantizing all first weights of the r^{th} layer of the neural network model is as follows. Statistics on data distribution of the first weights of the r^{th} layer is collected, including a minimum value min_val_r and a maximum value max_val_r of the first weights of the r^{th} layer. Then, a scaling factor and a quantization offset of the first weight of the r^{th} layer are calculated:

$$\begin{matrix}{scale}_{r} = \frac{max\_val \_r - min\_val \_r}{{2}^{{n}_{r}} - 1} \\ {offset}_{r} = round ( ( - {2}^{{n}_{r} - 1} ) - \frac{min\_val \_r}{{scale}_{r}} )\end{matrix}$$

Herein, scaler is the scaling factor of the r^{th} layer of the neural network model, offset is the quantization offset of the r^{th} layer of the neural network model, min_val_r is the minimum value of the first weights of the r^{th} layer, max_val_r is the maximum value of the first weights of the r^{th} layer, round( ) is rounding, and nᵣ is a quantity of bits used for the r^{th} layer of the neural network model, for example, 2 bits or 4 bits.

Finally, all the first weights of the r^{th} layer of the neural network model are quantized based on the scaling factor scaler and the quantization offset offsetᵣ.

S1125: Determine fitness of a neural network model obtained after quantization is performed through each quantization bit sequence in the fifth quantization bit set.

In some more specific embodiments, the fitness of the neural network model may be evaluated through the quantization error (mean square error (MSE)) and model prediction precision. It may be understood that each quantization bit sequence in the fifth quantization bit set corresponds to one piece of fitness of the neural network model. For example, if the fifth quantization bit set includes {Y₁, Y₂, . . . , Yₐ}, the quantization bit sequence Y₁ corresponds to fitness Z₁ of the neural network model, the quantization bit sequence Yₐ corresponds to fitness Z₂ of the neural network model, . . . , and the quantization bit sequence Y₂ corresponds to fitness Zₐ of the neural network model.

S1126: Select k quantization bit sequences with highest fitness as a new first quantization bit set, repeat steps S1121 to S1126 for a plurality of times until a quantity of repetition times reaches a threshold, and determine a final first quantization bit set as the second quantization bit set.

S1127: Select a quantization bit sequence with highest fitness from the second quantization bit set as the quantization bits of the neural network model.

It should be understood that in the foregoing solution, a quantity of quantization bit sequences in the first quantization bit set, a quantity of quantization bit sequences in the third quantization bit set, a quantity of quantization bit sequences in the fourth quantization bit set, a quantity K of quantization bit sequences with highest fitness, the change probability P, a fitness indicator, a quantity of evolution times, and the like may all be set as required.

S120: Quantize the first weight of each layer based on a quantization parameter to obtain a second weight of each layer, where the quantization parameter may include a scaling factor, a quantization offset, a rounding manner, and the like, a quantization manner in this step is similar to that in step S1124, and details are not described herein again.

S130: Determine whether a neural network model using the second weight meets a precision requirement, and if the precision requirement is not met, perform step S140; or if the precision requirement is met, perform step S150.

S140: Optimize the second weight.

In some more specific embodiments, optimizing the quantization parameter may include optimizing at least one of the scaling factor, the quantization offset, and the rounding manner.

The scaling factor and the quantization offset may be optimized in the following manner:

$${arg min}_{scale , offset} L ( W , round ( \frac{W}{scale} ) + offset )$$

Herein, L( ) represents a quantization error calculation function (for example, a mean square error before and after weight quantization), W is a model weight, scale is the scaling factor, offset is the quantization offset, and round( ) is the rounding manner.

The rounding manner may be optimized in the following manner:

$${arg min}_{Δ} L ( W , round ( \frac{W}{scale} + Δ ) + offset )$$

Herein, L( ) represents the quantization error calculation function (for example, the mean square error before and after weight quantization), W is the model weight, scale is the scaling factor, offset is the quantization offset, round( ) is the rounding manner, and Δ represents a disturbance tensor that needs to be introduced (a shape is the same as that of W). A rounding direction of W/scale is changed. When the rounding manner round( ) is optimized, scale and offset are fixed.

In some more specific embodiments, the second weight may be optimized by performing knowledge migration on a student model through a teacher model, to optimize the second weight. The teacher model may be a neural network model obtained through training with a large amount of known data and known labels, and a first weight of each layer of the teacher model is a floating-point number. The student model may be a neural network model obtained by quantizing the teacher model through step S110 to step S140, and a second weight of each layer of the student model is an integer. Network structures of the teacher model and the student model may be the same. For example, a quantity of layers of the teacher model, a quantity of nodes at each layer, and the like are all the same as those of the student model. The performing knowledge migration on a student model through a teacher model may be inputting a plurality of pieces of unlabeled data into the teacher model for prediction, to obtain predicted labels of the plurality of pieces of unlabeled data, and then using the plurality of pieces of unlabeled data and the predicted labels corresponding to the plurality of pieces of unlabeled data as input of the student model, to repeatedly train the student model for a plurality of times to further change the second weight in the student model; or inputting a plurality of pieces of unlabeled data into the teacher model for prediction, to obtain an intermediate feature of the teacher model, and then causing the student model to learn the intermediate feature of the teacher model to further change the second weight in the student model. It should be understood that in addition to training the student model with the unlabeled data, the student model may be trained with reference to some labeled data. This is not specifically limited herein.

S150: Generate a quantized neural network model.

The second weight of each layer or the third weight of each layer may be combined, to reduce a requirement for storage space and adapt to processors supporting different quantities of bits. For example, it is assumed that a second weight of the first layer is 4-bit, and a second weight of the second layer is 2-bit. In this case, if a quantity of bits supported by the processor is 8 bits, two second weights of the first layer may be combined together to form an 8-bit combined weight, and four second weights of the second layer may be combined together to form an 8-bit combined weight; or if a quantity of bits supported by the processor is 16 bits, four second weights of the first layer may be combined together to form a 16-bit combined weight, and eight second weights of the second layer may be combined together to form a 16-bit combined weight. In this way, the requirement for the storage space is effectively reduced, and a plurality of processors supporting different quantities of bits can be supported. When the neural network model needs to be used, a combined weight of each layer is split to obtain the second weight of each layer or the third weight of each layer of the neural network model. For example, it is assumed that the combined weight is 01101011, which is obtained by combining four 2-bit second weights or third weights. In this case, the combined weight may be split into the four 2-bit second weights or third weights, that is, 01, 10, 10, and 11.

To improve calculation precision of the neural network model, dequantization calculation may be performed on the second weight or the third weight of each layer, to obtain a restored first weight. In a specific implementation, dequantization calculation may be performed in the following manner:

$$X = scale * ( Y - offset )$$

Y is the second weight or the third weight. scale is the scaling factor. offset is the quantization offset. X is the restored first weight. Dequantization calculation is performed on the second weight or the third weight of each layer to obtain the restored first weight, and the restored weight is a value of the floating-point type. Therefore, input data of a neural network model generated with the restored first weight does not need to be converted into an integer for calculation, and a quantization error caused by quantization of the input data is also effectively avoided because the more quantization times, the more quantization errors are caused.

FIG. 4 is a schematic diagram of a structure of a model compression apparatus according to this application. As shown in FIG. 4, the model compression apparatus in this application includes an obtaining module 110 configured to obtain a first weight of each layer of a neural network model, where the first weight of each layer is a value of a floating-point type; and a quantization module 120 configured to quantize the first weight of each layer based on a quantization parameter to obtain a second weight of each layer, where the second weight of each layer is a multi-bit integer, quantities of bits of second weights of at least a part of layers are different, and a quantity of quantization bits of a second weight of a layer with high sensitivity to a quantization error is greater than a quantity of quantization bits of a second weight of a layer with low sensitivity to the quantization error.

The obtaining module 110 is configured to perform step S110 in the model compression method shown in FIG. 1. The quantization module 120 is configured to perform step S120 in the model compression method shown in FIG. 1.

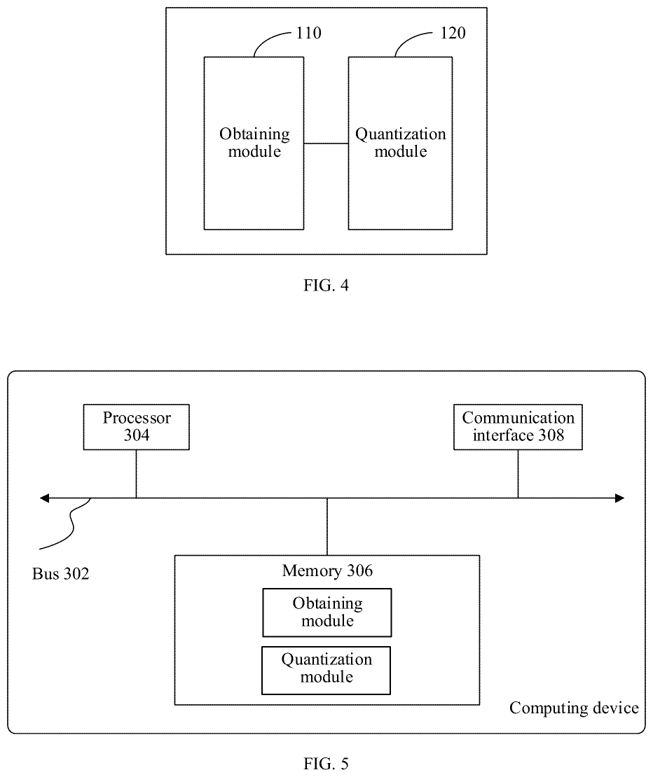

This application further provides a computing device. As shown in FIG. 5, the computing device includes a bus 302, a processor 304, a memory 306, and a communication interface 308. The processor 304, the memory 306, and the communication interface 308 communicate with each other through the bus 302. The computing device may be a server or a terminal device. It should be understood that quantities of processors and memories of the computing device are not limited in this application.

The bus 302 may be a Peripheral Component Interconnect (PCI) bus, an Extended Industry Standard Architecture (EISA) bus, or the like. The bus may be classified as an address bus, a data bus, a control bus, or the like. For ease of representation, only one line is used for representation in FIG. 5, but it does not mean that there is only one bus or only one type of bus. The bus 302 may include a path for transmitting information between components (for example, the memory 306, the processor 304, and the communication interface 308) of the computing device.

The processor 304 may include any one or more of processors such as a central processing unit (CPU), a graphics processing unit (GPU), a microprocessor (MP), or a digital signal processor (DSP).

The memory 306 may include a volatile memory, for example, a random-access memory (RAM). The memory 306 may further include a non-volatile memory, for example, a read-only memory (ROM), a flash memory, a hard disk drive (HDD), or a solid-state drive (SSD).

The memory 306 stores executable program code. The processor 304 executes the executable program code to separately implement functions of the obtaining module 110 and the quantization module 120, to implement step S110 to step S150 in the model compression method shown in FIG. 1. In other words, the memory 306 stores instructions used to perform step S110 to step S150 in the model compression method shown in FIG. 1.

Alternatively, the memory 306 stores executable code. The processor 304 executes the executable code to separately implement functions of the foregoing model compression apparatus, to implement step S110 to step S150 in the model compression method shown in FIG. 1. In other words, the memory 306 stores instructions used to perform step S110 to step S150 in the model compression method shown in FIG. 1.

The communication interface 308 uses a transceiver module, for example, but not limited to, a network interface card or a transceiver, to implement communication between the computing device and another device or a communication network.

An embodiment of this application further provides a computing device cluster. The computing device cluster includes at least one computing device. The computing device may be a server, for example, a central server, an edge server, or a local server in a local data center. In some embodiments, the computing device may alternatively be a terminal device, for example, a desktop computer, a notebook computer, or a smartphone.

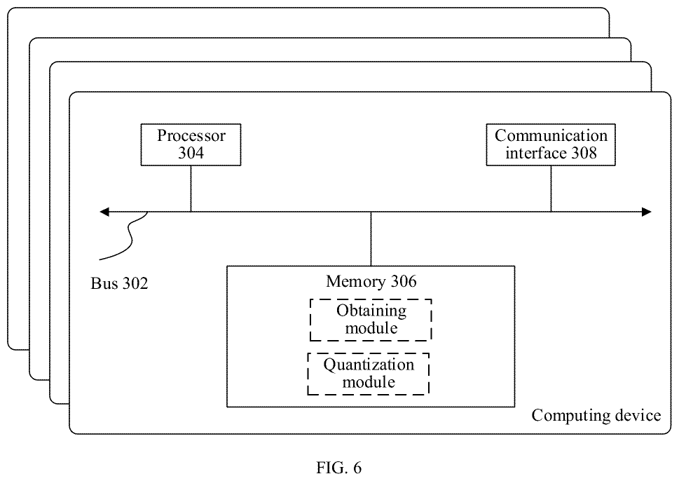

As shown in FIG. 6, the computing device cluster includes the at least one computing device. Memories 306 of one or more computing devices in the computing device cluster may store same instructions used to perform step S110 to step S150 in the model compression method.

In some possible implementations, the memories 306 of the one or more computing devices in the computing device cluster may separately store some instructions used to perform step S110 to step S150 in the model compression method shown in FIG. 1. In other words, the one or more computing devices may be combined to jointly execute the instructions for the aspects of step S110 to step S150 in the model compression method shown in FIG. 1.

It should be noted that memories 306 of different computing devices in the computing device cluster may store different instructions to separately perform some functions of the model compression apparatus. In other words, instructions stored in the memories 306 of the different computing devices may implement functions of one or more modules in the obtaining module and the quantization module.

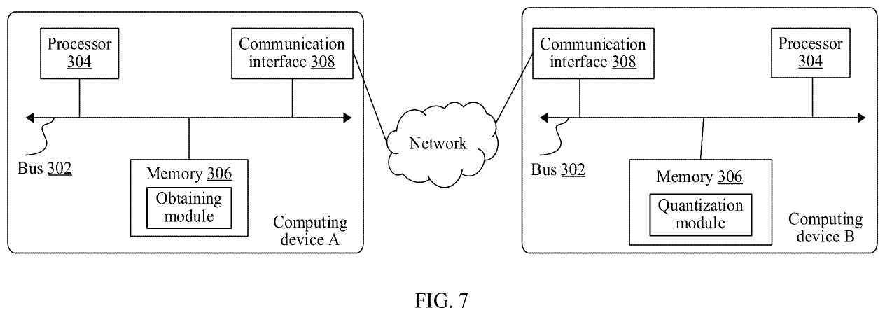

In some possible implementations, the one or more computing devices in the computing device cluster may be connected through a network. The network may be a wide area network, a local area network, or the like. FIG. 7 shows a possible implementation. As shown in FIG. 7, two computing devices A and B are connected through the network. Further, each computing device is connected to the network through a communication interface of the computing device. In this possible implementation, a memory 306 of the computing device A stores an instruction for performing a function of the obtaining module. In addition, a memory 306 of the computing device B stores an instruction for performing a function of the quantization module.

A connection manner of the computing device cluster shown in FIG. 7 may be that in consideration of a requirement of the model compression method provided in this application for storage of a large amount of data and calculation on a large amount of data, the quantization module is considered to be executed by the computing device B.

It should be understood that functions of the computing device A shown in FIG. 7 may also be completed by a plurality of computing devices. Similarly, functions of the computing device B may also be completed by a plurality of computing devices.

An embodiment of this application further provides another computing device cluster. For a connection relationship between computing devices in the computing device cluster, reference may be made to the connection manners of the computing device cluster in FIG. 6 and FIG. 7. A difference is that memories 306 of one or more computing devices in the computing device cluster may store same instructions used to perform step S110 to step S150 in the model compression method.

In some possible implementations, the memories 306 of the one or more computing devices in the computing device cluster may separately store some instructions used to perform step S110 to step S150 in the model compression method. In other words, the one or more computing devices may be combined to jointly execute the instructions used to perform step S110 to step S150 in the model compression method.

It should be noted that memories 306 of different computing devices in the computing device cluster may store different instructions to perform some functions of the cloud system. In other words, instructions stored in the memories 306 of the different computing devices may implement functions of one or more apparatuses of the model compression apparatus.

An embodiment of this application further provides a computer program product including instructions. The computer program product may be software or a program product that includes instructions and that can run on a computing device or be stored in any usable medium. When the computer program product runs on at least one computing device, the at least one computing device is caused to perform a model compression method.

An embodiment of this application further provides a computer-readable storage medium. The computer-readable storage medium may be any usable medium that can be stored in a computing device, or a data storage device, for example, a data center, including one or more usable media. The usable medium may be a magnetic medium (for example, a floppy disk, a HDD, or a magnetic tape), an optical medium (for example, a DIGITAL VERSATILE DISC (DVD)), a semiconductor medium (for example, a SSD), or the like. The computer-readable storage medium includes instructions. The instructions instruct the computing device to perform a model compression method.

When the computer program instructions are loaded and executed on a computer, all or some of the procedures or functions according to embodiments of the present disclosure are generated. The computer may be a general-purpose computer, a dedicated computer, a computer network, or another programmable apparatus.

The computer instructions may be stored in the computer-readable storage medium, or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage node, for example, a server or a data center, including at least one usable medium set. The usable medium may be a magnetic medium (for example, a floppy disk, a HDD, or a magnetic tape), an optical medium (for example, a high-density DVD), or a semiconductor medium.

The foregoing descriptions are merely specific embodiments of the present disclosure, but are not intended to limit the protection scope of the present disclosure. Any modification or replacement readily figured out by a person skilled in the art within the technical scope disclosed in the present disclosure shall fall within the protection scope of the present disclosure. Therefore, the protection scope of the present disclosure shall be subject to the protection scope of the claims.

1. A method comprising:
obtaining first weights of layers of a neural network model, wherein the first weights are floating-point type values, and wherein the layers comprise a first layer with a higher sensitivity to a quantization error and a second layer with a lower sensitivity to the quantization error;
generating quantization bits of the neural network model; and
quantizing the first weights based on the quantization bits and quantization parameters to obtain second weights of the layers,
wherein the second weights are multi-bit integers,
wherein the second weights comprise a third weight of the first layer and a fourth weight of the second layer, and
wherein a first quantity of the quantization bits of the third weight is greater than a second quantity of the quantization bits of the fourth weight.

2. The method of claim 1, wherein the quantization bits comprise a third quantity of bits of each of the layers.

3. The method of claim 1, wherein generating the quantization bits comprises:
randomly generating a first quantization bit set, wherein the first quantization bit set comprises first quantization bit sequences, and wherein each of the first quantization bit sequences comprises a third quantity of bits of each of the layers;
performing iterative variation on the first quantization bit sequences for a plurality of times, and selecting a target quantization bit sequence from the first quantization bit sequences obtained through the iterative variation to obtain a second quantization bit set; and
selecting a quantization bit sequence from the second quantization bit set as the quantization bits.

4. The method of claim 3, wherein performing the iterative variation comprises:
obtaining a third quantization bit set through variation based on the first quantization bit set, wherein the third quantization bit set comprises a fifth quantity of third quantization bit sequences;
randomly generating a fourth quantization bit set, wherein the fourth quantization bit set comprises a sixth quantity of fourth quantization bit sequences, and wherein the sixth quantity is equal to the fourth quantity minus the fifth quantity;
merging the third quantization bit set and the fourth quantization bit set to obtain a fifth quantization bit set, wherein the fifth quantization bit set comprises fifth quantization bit sequences;
quantizing the first weights based on a seventh quantity of bits of each of the layers in each of the fifth quantization bit sequences;
determining fitness of the neural network model by performing quantization on the first weights using each of the fifth quantization bit sequences;
selecting sixth quantization bit sequences from the fifth quantization bit set with highest fitness as a new quantization bit set;
repeating the foregoing steps for a plurality of times until a quantity of repetition times reaches a threshold; and
obtaining a final quantization bit set from the sixth quantization bit sequences as the second quantization bit set when the threshold has reached.

5. The method of claim 1, further comprising optimizing the second weights to obtain third weights of the layers when the second weights do not meet a precision requirement, wherein the third weights are multi-bit integers.

6. The method of claim 5, wherein optimizing the second weights comprises optimizing the quantization parameters, and wherein the quantization parameters comprise at least one of a scaling factor, a quantization offset, or a rounding manner.

7. The method of claim 5, wherein optimizing the second weights comprises optimizing a student model through a teacher model to optimize the second weights, wherein the teacher model is a first neural network model using the first weights, and wherein the student model is a second neural network model using the second weights.

8. The method of claim 5, further comprising combining the second weights or the third weights to obtain a combined weight of the layers, wherein a third quantity of the quantization bits of the combined weight is the same as a fourth quantity of the quantization bits supported by a processor using the neural network model.

9. The method of claim 8, further comprising splitting the combined weight to obtain the second weights or the third weights.

10. The method of claim 5, further comprising performing dequantization calculation on the second weights or the third weights to obtain a restored first weight of the layers.

11. A device comprising:
a memory configured to store instructions; and
one or more processors coupled to the memory, wherein the instructions when executed by the one or more processors, cause the device to:
obtain first weights of layers of a neural network model, wherein the first weights are floating-point type values, and wherein the layers comprise a first layer with a higher sensitivity to a quantization error and a second layer with a lower sensitivity to the quantization error;
generate quantization bits of the neural network model; and
quantize the first weights based on the quantization bits and quantization parameters to obtain second weights of the layers,
wherein the second weights are multi-bit integers,
wherein the second weights comprise a third weight of the first layer and a fourth weight of the second layer, and
wherein a first quantity of the quantization bits of the third weight is greater than a second quantity of the quantization bits of the fourth weight.

12. The device of claim 11, wherein the quantization bits comprise a third quantity of bits of each of the layers.

13. The device of claim 11, wherein the instructions, when executed by the one or more processors, further cause the device to:
randomly generate a first quantization bit set, wherein the first quantization bit set comprises a fourth quantity of first quantization bit sequences, and wherein each of the first quantization bit sequences comprises a third quantity of bits of each of the layers;
perform iterative variation on the first quantization bit sequences for a plurality of times, and select a target quantization bit sequence from the first quantization bit sequences obtained through the iterative variation to obtain a second quantization bit set; and
select a quantization bit sequence from the second quantization bit set as the quantization bits.

14. The device of claim 13, wherein in a manner to perform the iterative variation, the instructions, when executed by the one or more processors, further cause the device to:
obtain a third quantization bit set through variation based on the first quantization bit set, wherein the third quantization bit set comprises a fifth quantity of third quantization bit sequences;
randomly generate a fourth quantization bit set, wherein the fourth quantization bit set comprises a sixth quantity of fourth quantization bit sequences, and wherein the sixth quantity is equal to the fourth quantity minus the fifth quantity;
merge the third quantization bit set and the fourth quantization bit set to obtain a fifth quantization bit set, wherein the fifth quantization bit set comprises fifth quantization bit sequences;
quantize the first weights based on a seventh quantity of bits of each of the layers in each of the fifth quantization bit sequences;
determine fitness of the neural network model by performing quantization on the first weights using each of the fifth quantization bit sequences;
select sixth quantization bit sequences from the fifth quantization bit set with highest fitness as a new quantization bit set;
repeat the foregoing steps for a plurality of times until a quantity of repetition times reaches a threshold; and
obtain a final quantization bit set from the sixth quantization bit sequences as the second quantization bit set when the threshold has reached.

15. The device of claim 11, wherein the instructions, when executed by the one or more processors, further cause the device to optimize the second weights to obtain third weights of the layers when the second weights do not meet a precision requirement, and wherein the third weights are multi-bit integers.

16. The device of claim 15, wherein the instructions, when executed by the one or more processors, further cause the device to optimize the quantization parameters, and wherein the quantization parameters comprise at least one of a scaling factor, a quantization offset, or a rounding manner.

17. The device of claim 15, wherein the instructions, when executed by the one or more processors, further cause the device to optimize a student model through a teacher model to optimize the second weights, and wherein the teacher model is a first neural network model using the first weights, and wherein the student model is a second neural network model using the second weights.

18. The device of claim 15, wherein the instructions, when executed by the one or more processors, further cause the device to combine the second weights or the third weights to obtain a combined weight of the layers, and wherein a third quantity of the quantization bits of the combined weight is the same as a fourth quantity of the quantization bits supported by the one or more processors using the neural network model.

19. The device of claim 18, wherein the instructions, when executed by the one or more processors, further cause the device to split the combined weight to obtain the second weights or the third weights.

20. A computer program product comprising computer-executable instructions that are stored on a non-transitory computer-readable medium and that, when executed by one or more processors, cause a device to:
obtain a first weights of layers of a neural network model, wherein the first weights are a floating-point type values, and wherein the layers comprise a first layer with a higher sensitivity to a quantization error and a second layer with a lower sensitivity to the quantization error;
generate quantization bits of the neural network model; and
quantize the first weights based on the quantization bits and quantization parameters to obtain second weights of the layers,
wherein the second weights are multi-bit integers,
wherein the second weights comprise a third weight of the first layer and a fourth weight of the second layer, and
wherein a first quantity of the quantization bits of the third weight is greater than a second quantity of the quantization bits of the fourth weight.
